(19) United States
(12) Patent Application Publication
(10) Pub. No.: US 2014/0290341 A1
(43) Pub. Date: Oct. 2, 2014

(54) Detection of a Compromised Flow Line in a Laboratory Instrument

(71) Applicants: Amirthaganesh Subramanian, San Jose, CA (US); Jeffrey Sugarman, Los Altos, CA (US); Chiming Frank Huang, San Jose, CA (US)

(72) Inventors: Amirthaganesh Subramanian, San Jose, CA (US); Jeffrey Sugarman, Los Altos, CA (US); Chiming Frank Huang, San Jose, CA (US)

(73) Assignee: BECTON, DICKINSON AND COMPANY, Franklin Lakes, NJ (US)

(21) Appl. No.: 14/234,116

(22) PCT Filed: Jul. 20, 2012
(86) PCT No.: PCT/US2012/047738

§ 371 Date: Apr. 22, 2014

Related U.S. Application Data
(60) Provisional application No. 61/514,668, filed on Aug. 3, 2011.

(51) Int. Cl. G01M 3/02

(52) U.S. Cl. CPC G01M 3/02
USPC 73/37

(57) ABSTRACT

Provided herein are systems and methods for detecting a compromised flow line in a laboratory instrument. In one embodiment, for example, the system includes: (1) a wash station in fluid communication with a sample probe; (2) a fluid line coupled to the wash station to withdraw fluid from the wash station and deliver the fluid to a waste tank; and (3) a vacuum transducer, coupled to the fluid line, to measure vacuum pressure per unit time within the fluid line. The vacuum pressure per unit time is then used to detect a compromised flow line (e.g., a clog, occlusion, opening, etc. in the flow line).

### CROSS-REFERENCE TO RELATED APPLICATIONS

Pursuant to 35 U.S.C. §119 (e) this application claims priority to the filing date of U.S. Provisional Patent Application Ser. No. 61/514,668 filed Aug. 3, 2011; the disclosure of which application is herein incorporated by reference.

### INTRODUCTION

The present invention relates to laboratory instruments such as flow cytometers. More specifically, the present invention relates to systems and methods for detecting a compromised flow line in a laboratory instrument.

Flow cytometers, for example, are valuable laboratory instruments for the analysis and isolation of biological particles, such as cells and constituent molecules. Flow cytometers utilize a fluid stream to linearly segregate particles such that they can pass, single file, through a detection apparatus measuring light scattering and/or fluorescence. Individual cells can then be characterized according to their scattering and the presence of detectable markers. Thus, a flow cytometer can be used to produce a diagnostic profile of a population of biological particles.

The preparation of samples for flow cytometry can require accurate dispensing of biological specimens and reagents. In such cases, detecting problems with a dispensing system used in conjunction with flow cytometry is key to preventing the detection system from providing inaccurate results. In addition, the accurate delivery of sample fluid into a flow cytometer detector may rely on an unobstructed flow through a probe and transfer line.

In these ways, processing of fluid and/or samples through the instrument's flow lines (for sample preparation, sample acquisition, and cleaning) requires uncompromised passageways. For example, one probe is generally used for sample preparation, while another is used for transfer of sample for analysis. Clogs or occlusions in the probes may be created by protein build-up or drying of blood within the probe when the instrument suffers a power failure during the sample preparation process; by particles lodged in the flow line; failure of liquid filters; misconnected fittings; failed valves and/or pumps; etc.

### SUMMARY

The systems and methods described herein are used to detect a compromised (e.g., clogged, occluded, open, etc.) flow line in a laboratory instrument. In one embodiment, for example, the systems and methods presented are used to detect a clog or occlusion in a probe used for sample preparation and delivery in a flow cytometer.

Probes are typically rinsed or washed by forcing liquid through the probe via a pump or a pressure source. The rinsing action typically occurs at a wash station. The liquid from the wash station is then convected to a waste tank via a liquid pump (e.g., a waste pump). In one embodiment, a vacuum transducer is connected at the suction side of the pump, and the transducer monitors the vacuum level (or pressure trace) at the inlet side of the pump. The pressure trace measured by the vacuum transducer will differ depending on whether the waste pump is pulling air or liquid. When the probe is completely clogged, no liquid will flow through the probe and into the wash station, and as such the waste pump will be pulling air exclusively. In this way, the vacuum transducer can detect a change in the pressure trace resulting from a clog upstream in the probe. In other words, when air alone is aspirated by the waste pump, the level of vacuum is lower compared to the case when liquid is being aspirated. The system thus monitors the change in vacuum level during the period when rinsing takes place, and determines if the probe is clogged or clog-free, or whether the flow line is otherwise compromised.

The systems and methods presented may also be used to monitor the health of the waste pump, and to ensure positive connectivity between the waste pump and the waste collection tank. Also, the vacuum level may be used to detect the complete or gradual failure of the waste pump.

Additional advantages and embodiments are provided below.

### BRIEF DESCRIPTION OF THE FIGURES

The accompanying drawings, which are incorporated herein, form part of the specification. Together with this written description, the drawings further serve to explain the principles of, and to enable a person skilled in the relevant art(s), to make and use systems and methods in accordance with the present invention.

FIG. 1 is a schematic representation of a system in accordance with one embodiment.

FIG. 2 is a typical pressure trace when the waste pump is aspirating only air.

FIG. 3 is a typical pressure trace when the waste pump is aspirating an air-liquid mixture.

FIG. 4 is a perspective view of a wash station in accordance with one embodiment presented.

### DETAILED DESCRIPTION

The systems and methods described herein are used to detect a compromised (e.g., clogged, occluded, open, etc.) flow line in a laboratory instrument.

In one embodiment, for example, the systems and methods presented are used to detect a clog or occlusion in the probe used for sample preparation and delivery in a flow cytometer. In general, the systems presented include a vacuum transducer connected at the suction side of a waste pump. The vacuum transducer monitors the vacuum level (or pressure trace) at the inlet side of the pump. The pressure trace measured by the vacuum transducer will differ depending on whether the waste pump is pulling air or liquid from a wash station. When the probe is clogged, no liquid will flow through the probe and into the wash station, and as such the waste pump will be pulling air. The vacuum transducer can then detect a change in the pressure trace, indicating a clog upstream in the probe. In other words, when air alone is aspirated by the waste pump, the level of vacuum is lower compared to the case when liquid is being aspirated. The system thus monitors the change in vacuum level during the period when rinsing takes place, and determines if the probe is clogged or clog-free, or whether the flow line is otherwise compromised.

It is noted that, as used herein, to “detect” a compromised flow line, or to “determine whether the flow line is compromised,” does not require an absolute determination of a compromised (e.g., clogged, occluded, open, etc.) flow line. However, the systems and methods presented allow a user to improve the probabilities of identifying a problem in the laboratory instrument.

The systems and methods described herein may also be used to monitor the health of the waste pump, and to ensure positive connectivity between the waste pump and the waste collection tank. The vacuum level (e.g., very low values) can also be used to detect the complete or gradual failure of the waste pump (for both diaphragm or peristaltic pumps). As such, there is a reduced need for providing visual access and inspection to such components. Also, the present invention removes the need for a pressure sensor on the probe itself, which is inconvenient and adds complexity to the flow line.

The following detailed description of the figures refers to the accompanying drawings that illustrate an exemplary embodiment of systems and methods for detecting a compromised flow line in a laboratory instrument. Other embodiments are possible. Modifications may be made to the embodiment described herein without departing from the spirit and scope of the present invention. Therefore, the following detailed description is not meant to be limiting.

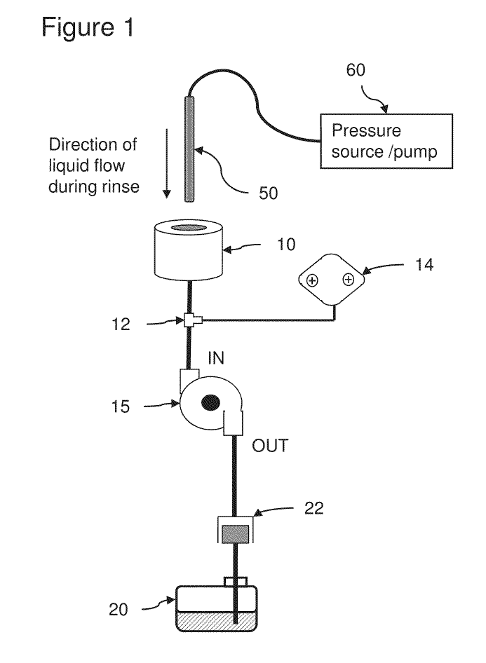

FIG. 1 is a schematic representation of a system in accordance with one embodiment. As shown, a sample probe 50 is presented to a wash station 10. Sample probe 50 is generally a probe used for the collection, preparation, and distribution of fluids, as would be understood to one of skill in the art, in a laboratory instrument. Sample probe 50 may remain completely outside of wash station 10, or may alternatively be partially or fully inserted into wash station 10. Sample probe 50, however, is in fluid communication with (i.e., capable of delivering fluid to) wash station 10, such that pressure source/pump 60 pushes liquid flow through probe 50 during a rinse/wash cycle. As such, fluid within probe 50 is delivered to wash station 10.

A fluid conduit is then provided between wash station 10 and the input (or suction) side of a waste pump 15. In one embodiment, waste pump is a dual-head, diaphragm type liquid pump available from KNF Neuberger, Inc, Model NFT30. A vacuum transducer 14 is coupled to the fluid conduit at fitting 12. Vacuum transducer 14 is provided to monitor the vacuum pressure within the fluid conduit. More specifically, vacuum transducer 14 evaluates a pressure trace within the fluid conduit to determine whether wash station 10 is receiving fluid from probe 50. If fluid is expected from probe 50, but is not received from the probe, then the system can alert a user that the probe (or system in general) is compromised (e.g., there may be a clog in probe 50). A timing synchronization circuit (not shown) may be coupled to vacuum transducer 14 in order to identify when fluid is expected in wash station 10. Further, an external processor (not shown) may be coupled to vacuum transducer 14 in order to evaluate the vacuum pressure trace measured by the vacuum transducer. In one embodiment, an STR912 32-bit ARM based microprocessor from STMicroelectronics is used to monitor the vacuum pressure from the transducer device. An ADC device is embedded in the microprocessor to interface with the transducer device. However, any microprocessor that provides interface to communicate with the transducer device shall work.

In one embodiment, vacuum transducer 14 is a printed circuit board (PCB) -mounted SenSym ICT, available from Honeywell™, Model SDX15G2 0-15PSI 20VDC DIP-6. Though this sensor is a pressure sensor, the vacuum or negative pressure is read by reversing the polarity between the sensor and the amplifier. For improved resolution a sensor in the range 0-5 psi may be used. By suitable choice of the sensor with finer resolution, even a partial clog in probe 50 may be identified. In applications where there is a large range in vacuum levels, two or more sensors may be used in parallel to improve the resolution of vacuum tracking.

Waste pump 15 may be a diaphragm liquid pump or a peristaltic pump. Tubing from the output side of waste pump 15 is in fluid communication with tubing from the waste tank 20, via quick-disconnect fitting 22 with shut-off valves (e.g., Colder™ fittings). In the event the user fails to properly connect waste tank 20 to the flow line (e.g., at fitting 22) the vacuum level measured at transducer 14 will reach very low values as waste pump 15 will be “dead-headed.”

The system presented in FIG. 1 therefore provides a method for detecting various failures related to a flow line, such as a clog or leak in the upstream line, failure of the upstream pump, clogging of the sample probe itself, or downnstream clogging or blockage of the waste path. Each of these can be detected by measuring a vacuum pressure downstream of the wash station that is intended to receive fluid from the probe. The clog detection technique presented is based on the difference in the level of vacuum when the pump is aspirating air or air/liquid mixture (i.e., an evaluation of the pressure trace identified in the fluid lines). In other words, monitoring the vacuum at the indicated position in FIG. 1 allows the detection of fluid flow past that point. But clogging of the probe is only one failure mode that causes fluid to not come out of the probe. Other possibilities of fluid not issuing out of the probe include: a disconnected fitting upstream of the probe; and/or failure of the upstream delivery pump that supplies wash fluid to the probe. Each of these will result in the same effect; i.e., failure to deliver fluid through the probe. Each of these can be detected using the methods described.

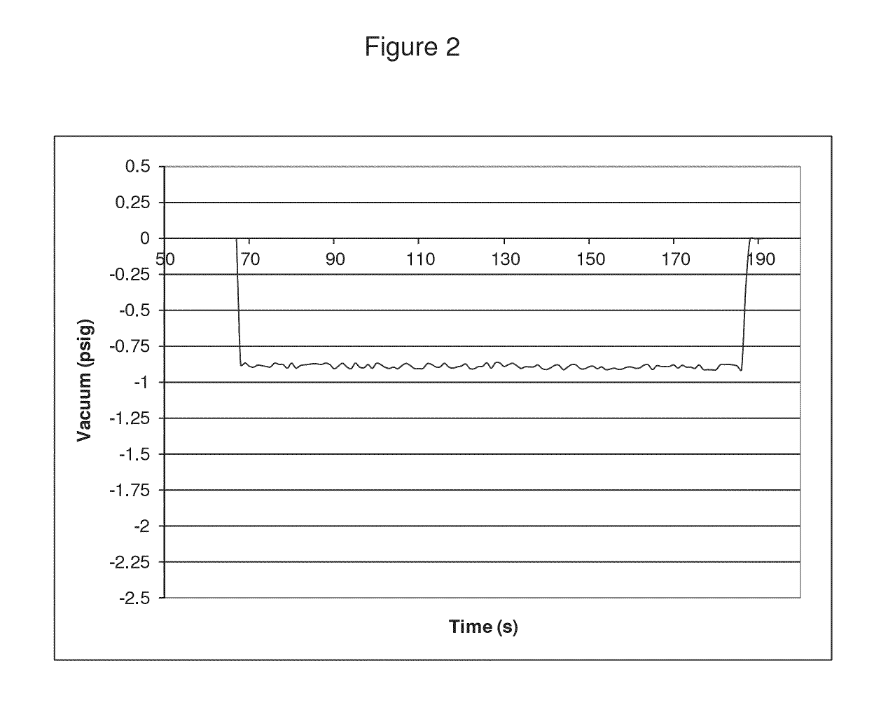

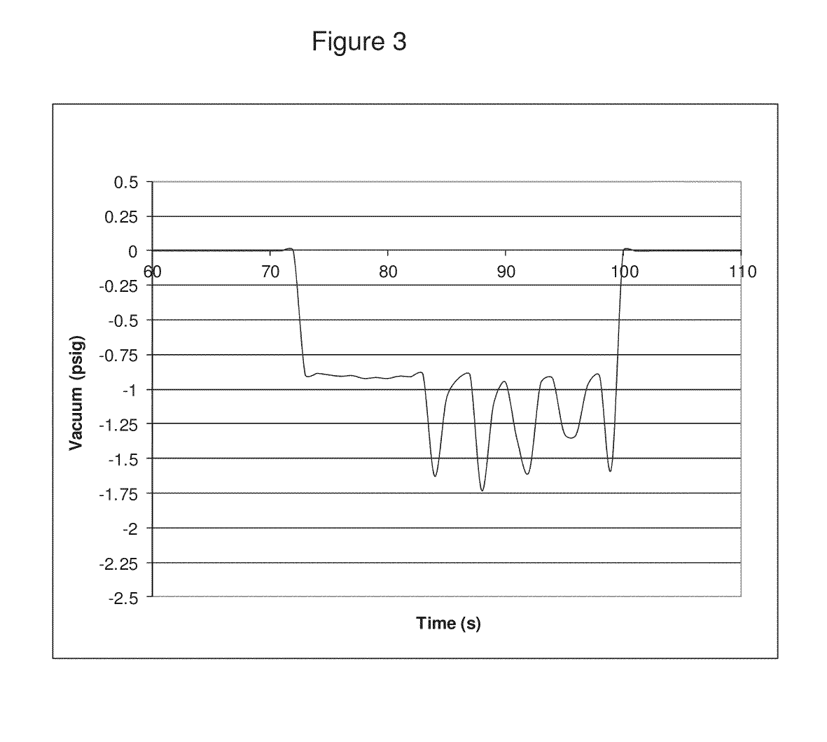

FIG. 2 is a typical pressure trace when the waste pump is aspirating only air. The vacuum level when air alone is aspirated is at −0.9 psig. FIG. 3 is a typical pressure trace when the waste pump is aspirating an air-liquid mixture (i.e., liquid is being pushed through an un-clogged probe via a syringe pump). The average peak vacuum level when air/liquid mixture is aspirated is about −1.5 psig. The vacuum level is higher when the liquid/air mixture is aspirated by the waste pump relative to the condition when air alone is aspirated.

To avoid spurious vacuum readings in the detection of a clog or pump failure, an averaging procedure may be used instead of relying on just one reading. For example, the vacuum value may be tested every 250 milliseconds for the entire duration of a rinse cycle, or portion of the cycle (depending on the pressure trace). In the pressure trace shown in FIG. 3, for the first 11 seconds, only air is being drawn by the waste pump, and the liquid/air mixture is getting aspirated for the remaining 17 seconds. The recorded values can be used to identify the peak values and obtain an average. The average value obtained from the rinse cycle may then be used to compare against the average value obtained for the air only aspiration case.

In the embodiment wherein the transducer is on the pressure side of the pump, the transducer will be measuring a pressure trace instead of a vacuum trace. In such case, the system would not be detecting an upstream clog, but rather: a disconnection of the waste tank fitting; a block in the waste line leading to the waste tank; and/or otherwise detecting unwanted pressurization of the waste tank.

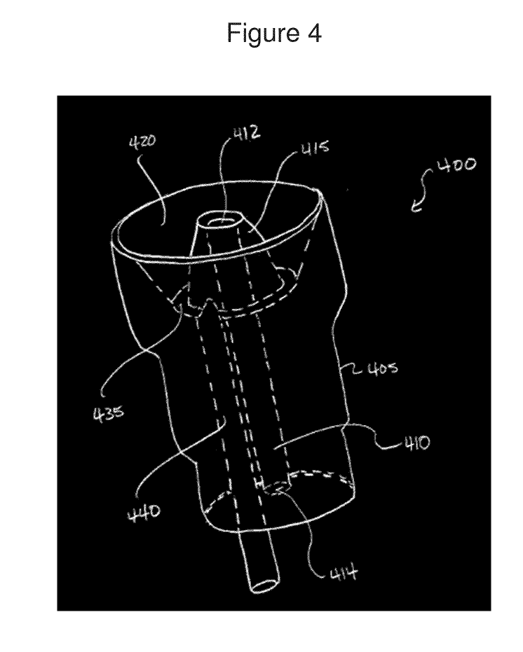

FIG. 4 is a perspective view of a wash station 400, in accordance with one embodiment presented. Wash station 400 includes a perimeter wall 405 and a central cavity 410. Central cavity 410 is designed for receiving at least a portion of a sample probe. Specifically, the sample probe is inserted through open end 412. When fluid is pushed out of the sample probe, and against closed end 414 of central cavity 410, the fluid overflows into an annular recess 435 formed between inner walls 415, 420. An output drain 440 is formed in annular recess 435 to withdraw overflow-fluid from the annular recess. For example, output drain 440 may be coupled to a waste pump 15 for drawing fluid from wash station 400 to waste tank 20. While wash station 400 is shown in a circular configuration, other shapes, sizes, and designs may be employed. Alternative wash stations include wash stations typically used for the disposal of sample or excess fluid, in laboratory instruments, as would be understood to one of skill in the art.

### Additional Embodiments

In another embodiment, there is provided a system for detecting a compromised flow line in a laboratory instrument, the system comprising: (1) a wash station in fluid communication with a sample probe; (2) a fluid line coupled to the wash station to withdraw fluid from the wash station and deliver the fluid to a waste tank; and (3) a vacuum transducer, coupled to the fluid line, to measure vacuum pressure per unit time within the fluid line. The system may further comprise: (4) a processor, coupled to the vacuum transducer, to evaluate a vacuum pressure trace measured by the vacuum transducer; (5) a timing synchronization circuit to identify when fluid is expected in the wash station; (6) a waste pump, coupled to the fluid line between the vacuum transducer and the waste tank, to create a vacuum on the wash station; and/or (7) a disconnect-fitting along the fluid line to disconnect the waste tank form the fluid line.

In still another embodiment, there is provided a flow line system for a laboratory instrument. The flow line system comprises a wash station for receiving fluid from a sample probe. The wash station includes a central cavity for receiving at least a portion of the sample probe. The central cavity has (i) a cavity wall, (ii) a closed end, and (iii) an open end. The wash station further includes an annular recess surrounding the open end of the central cavity, wherein fluid being dispensed from the sample probe into the central cavity overflows into the annular recess. The wash station also includes an output drain formed in the annular recess. The flow line system further includes a fluid line coupled to the output drain of the wash station to withdraw fluid from the annular recess and deliver the fluid to a waste tank. The flow line system also includes a transducer, coupled to the fluid line, to measure vacuum pressure per unit time within the fluid line. The flow line system may further comprise: (a) a processor, coupled to the transducer, to evaluate a vacuum pressure trace measured by the transducer; (b) a timing synchronization circuit to identify when fluid is expected in the wash station; (c) a waste pump, coupled to the fluid line between the transducer and the waste tank, to create a vacuum on the wash station; and/or (d) a disconnect-fitting along the fluid line to disconnect the waste tank form the fluid line.

In yet another embodiment, there is provided a wash station for use in a flow line system for a laboratory instrument. The wash station includes: (1) a perimeter wall; (2) a central cavity for receiving at least a portion of a sample probe, the central cavity having (i) a cavity wall, (ii) a closed end, and (iii) an open end; (3) an annular recess surrounding the open end of the central cavity, wherein fluid being dispensed from the sample probe into the central cavity overflows into the annular recess; and (4) an output drain formed in the annular recess.

In another embodiment, there is provided a method for detecting a compromised flow line in a laboratory instrument, the method comprising: (1) measuring a vacuum pressure per unit time within a fluid line with a vacuum transducer that is coupled to the fluid line between a wash station and a waste tank; and (2) determining whether the flow line of the laboratory instrument is compromised based on the vacuum pressure per unit time.

In still another embodiment, there is provided a method for detecting a clog in a flow line of a laboratory instrument, wherein the clog is upstream of a sample probe, the method comprising: (1) creating a vacuum at a wash station by use of a waste pump coupled to a fluid line, wherein the wash station is in fluid communication with a sample probe; and (2) measuring a vacuum pressure per unit time within the fluid line with a vacuum transducer that is coupled to the fluid line between a wash station and a waste tank, wherein variability in the vacuum pressure per unit time provides an indication of a clog in the flow line of the laboratory instrument, upstream of the sample probe. The method may further comprise: (3) coupling a vacuum transducer to a vacuum-side of the waste pump to measure the vacuum pressure per unit time within the fluid line; and/or (4) coupling a transducer to the pressure-side of the waste pump to measure the vacuum pressure per unit time within the fluid line.

### CONCLUSION

The foregoing description of the invention has been presented for purposes of illustration and description. It is not intended to be exhaustive or to limit the invention to the precise form disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

It is to be appreciated that the Detailed Description section, and not the Summary and Abstract sections, is intended to be used to interpret the claims. The Summary and Abstract sections may set forth one or more, but not all exemplary embodiments of the present invention as contemplated by the inventor(s), and thus, are not intended to limit the present invention and the appended claims in any way.

It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. All combinations of the embodiments are specifically embraced by the present invention and are disclosed herein just as if each and every combination was individually and explicitly disclosed, to the extent that such combinations embrace operable processes and/or devices/systems/kits. In addition, all sub-combinations listed in the embodiments describing such variables are also specifically embraced by the present invention and are disclosed herein just as if each and every such sub-combination of chemical groups was individually and explicitly disclosed herein.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

What is claimed is:

1. A system for determining whether a flow line in a laboratory instrument is compromised, the system comprising:
a wash station in fluid communication with a sample probe;
a fluid line coupled to the wash station to withdraw fluid from the wash station and deliver the fluid to a waste tank; and
a vacuum transducer, coupled to the fluid line, to measure vacuum pressure per unit time within the fluid line.

2. The system of claim 1, further comprising:
a processor, coupled to the vacuum transducer, to evaluate a vacuum pressure trace measured by the vacuum transducer.

3. The system of claim 2, further comprising:
a timing synchronization circuit to identify when fluid is expected in the wash station.

4. The system of claim 1, further comprising:
a waste pump, coupled to the fluid line between the vacuum transducer and the waste tank, to create a vacuum on the wash station.

5. The system of claim 1, further comprising:
a disconnect-fitting along the fluid line to disconnect the waste tank form the fluid line.

6. A flow line system for a laboratory instrument, the system comprising:
a wash station for receiving fluid from a sample probe, the wash station having
a central cavity for receiving at least a portion of the sample probe, the central cavity having (i) a cavity wall, (ii) a closed end, and (iii) an open end,
an annular recess surrounding the open end of the central cavity, wherein fluid being dispensed from the sample probe into the central cavity overflows into the annular recess, and
an output drain formed in the annular recess;
a fluid line coupled to the output drain of the wash station to withdraw fluid from the annular recess and deliver the fluid to a waste tank; and
a transducer, coupled to the fluid line, to measure vacuum pressure per unit time within the fluid line.

7. The system of claim 6, further comprising:
a processor, coupled to the transducer, to evaluate a vacuum pressure trace measured by the transducer.

8. The system of claim 7, further comprising:
a timing synchronization circuit to identify when fluid is expected in the wash station.

9. The system of claim 6, further comprising:
a waste pump, coupled to the fluid line between the transducer and the waste tank, to create a vacuum on the wash station.

10. The system of claim 6, further comprising:
a disconnect-fitting along the fluid line to disconnect the waste tank form the fluid line.

11. A method for detecting a compromised flow line in a laboratory instrument, the method comprising:
measuring a vacuum pressure per unit time within a fluid line with a vacuum transducer that is coupled to the fluid line between a wash station and a waste tank; and
determining whether the flow line of the laboratory instrument is compromised based on the vacuum pressure per unit time.

12. A method for determining whether a flow line of a laboratory instrument is compromised, wherein the clog is upstream of a sample probe, the method comprising:
creating a vacuum at a wash station by use of a waste pump coupled to a fluid line, wherein the wash station is in fluid communication with a sample probe; and
measuring a vacuum pressure per unit time within the fluid line with a vacuum transducer that is coupled to the fluid line between a wash station and a waste tank to detect whether a clog is present in the flow line.

13. The method of claim 12, further comprising:
coupling a vacuum transducer to a vacuum-side of the waste pump to measure the vacuum pressure per unit time within the fluid line.

14. The method of claim 12, further comprising:
coupling a transducer to the pressure-side of the waste pump to measure the vacuum pressure per unit time within the fluid line.

15. The method of claim 12, wherein variability in the vacuum pressure per unit time provides an indication of a clog in the flow line of the laboratory instrument, upstream of the sample probe.
